(19) United States
(12) Patent Application Publication
(10) Pub. No.: US 2016/0267800 A1
(43) Pub. Date: Sep. 15, 2016

(54) ELECTRONIC DEVICE AND METHOD FOR PROVIDING LEARNING INFORMATION USING THE SAME

(71) Applicant: GENIUS FACTORY INC., Incheon (KR)

(72) Inventor: Ju Hwan LEE, Incheon (KR)

(21) Appl. No.: 14/777,704

(22) PCT Filed: Jul. 31, 2015
(86) PCT No.: PCT/KR2015/008044

§ 371 Date: Sep. 16, 2015

(30) Foreign Application Priority Data
Nov. 3, 2014 (KR) 10-2014-0151246

(51) Int. Cl. G09B 5/06; G06F 9/44; G06F 3/0484; G06F 3/0488; G09B 7/00; G06F 3/0482

(52) U.S. Cl. CPC G09B 5/065; G09B 7/00; G06F 3/0482; G06F 3/04845; G06F 3/04842; G06F 3/04883; G06F 9/4446

(57) ABSTRACT

The present invention provides an electronic device and a method for providing learning information using the same. The electronic device comprises a storage unit storing at least one data regarding learning information; a touch screen receiving a user input and displaying the at least one data; and a control unit displaying a learning theme item and at least one learning sub-theme item related to the learning theme item through the touch screen by mapping the at least one learning sub-theme item to the learning theme item, receiving a predefined user input for the at least one learning sub-theme item, and controlling the touch screen to display a notification window including image data and text data regarding the at least one learning sub-theme item according to the predefined user input.

This application claims priority to Korean Patent Application No. 10-2014-0151246 filed on Nov. 3, 2011 in the Korean Intellectual Property Office, the disclosure of which is incorporated herein by reference in its entirety.

### BACKGROUND

1. Field of the Invention

The invention relates to a method of visually providing learning information to a user using various user interfaces (UIs) and an electronic device supporting the method.

2. Description of the Related Art

As the sensitivity of electronic parts increases and the size and weight of electronic parts decreases, electronic devices such as typical mobile terminals have increasingly become miniaturized, and the functions of the electronic devices have diversified according to customers' needs. Accordingly, not only a call function, but also a gaming function, an internet search function, an email function, and payment function, have become the common functions of electronic devices such as mobile terminals. Also, mobile terminals equipped with a camera function, which enables the taking of pictures with the mobile terminals by installing a camera lens in the mobile terminals, and an image transmission function, which allows the pictures to computers or other mobile terminals, have become commercialized.

Recently, systems for supporting learning with the use of content such as videos has been widely used in electronic devices such as mobile terminals. For the learning of a foreign language, in particular, such systems commonly provide learning information by classifying themes of learning into grammar, vocabulary, and conversation categories and allowing users to learn the foreign language according to each of the categories.

Learning content regarding English that is one of the subjects in the curriculum of public education is generally classified and provided by various electronic devices by grade in school.

A conventional system for providing learning information generally insists its users to follow a study schedule unilaterally organized by a supplier according to a predetermined education policy and thus may not be able to provide users with individual, customized learning information according to their level of knowledge or grade in school.

Also, the conventional learning information providing system provides learning information in a one-way manner and may thus make it difficult for users to practice self-directed learning.

Also, the type of learning information provided by the conventional learning information providing system is generally limited to text or video content, and thus may make it difficult to provide users with systematic and intuitive learning information.

Also, the conventional learning information providing system provides different places on the screen for providing learning information and for allowing users to post questions on any particular learning theme and may thus make it difficult for the system provider and users to effectively communicate with each other.

### SUMMARY

Exemplary embodiments of the invention provide an electronic device and method for providing learning information, which can effectively provide users with learning information using various user interface (UI) elements and can provide learning information according to a selection made by the users.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, there is provided an electronic device for providing learning information, the electronic device comprising a storage unit storing at least one data regarding learning information, a touch screen receiving a user input and displaying the at least one data, and a control unit displaying a learning theme item and at least one learning sub-theme item related to the learning theme item through the touch screen by mapping the at least one learning sub-theme item to the learning theme item, receiving a predefined user input for the at least one learning sub-theme item, and controlling the touch screen to display a notification window including image data and text data regarding the at least one learning sub-theme item according to the predefined user input.

According to another exemplary embodiment of the invention, there is provided an electronic device for providing learning information, the electronic device comprising a storage unit storing at least one data regarding learning information, a touch screen receiving a user input and displaying the at least one data, and a control unit controlling the touch screen to display a full-screen image, in which all learning theme items, all learning sub-theme items, and all additional learning sub-theme items included in the learning information are displayed at a predetermined reduced scale, according to a predefined user input.

According to still another exemplary embodiment of the invention, there is provided an electronic device for providing learning information, the electronic device comprising a storage unit storing at least one data regarding learning information, a touch screen receiving a user input and displaying the at least one data, and a control unit displaying a learning theme item and at least one learning sub-theme item related to the learning theme item through the touch screen by mapping the at least one learning sub-theme item to the learning theme item, receiving question input information for the at least one learning sub-theme item through the touch screen, generating a UI item including at least part of the question input information, and controlling the touch screen to display the UI item near the learning theme item or the at least one learning sub-theme item.

According to still another exemplary embodiment of the invention, there is provided a method of providing learning information using an electronic device, the method comprising displaying a learning theme item and at least one learning sub-theme item related to the learning theme item on the touch screen by mapping the at least one learning sub-theme item to the learning theme item, receiving a predefined user input for the at least one learning sub-theme item, and displaying a notification window including image data and text data regarding the at least one learning sub-theme item according to the predefined user input.

According to still another exemplary embodiment of the invention, there is provided a method of providing learning information using an electronic device, the method comprising displaying a learning theme item and at least one learning sub-theme item related to the learning theme item on the touch screen by mapping the at least one learning sub-theme item to the learning theme item, and displaying a full-screen image, in which all learning theme items, all learning sub-theme items, and all additional learning sub-theme items included in the learning information are displayed at a predetermined reduced scale, according to a predefined user input.

According to still another exemplary embodiment of the invention, there is provided a method of providing learning information using an electronic device, the method comprising displaying a learning theme item and at least one learning sub-theme item related to the learning theme item on the touch screen by mapping the at least one learning sub-theme item to the learning theme item, receiving question input information for the at least one learning sub-theme item from a user, generating a UI item including at least part of the question input information, and displaying the UI item near the learning theme item or the at least one learning sub-theme item.

According to the exemplary embodiments, it is possible to provide users with individual, customized learning information according to the users' level or knowledge and grade in school by allowing the user to select learning information and providing the selected learning information to the users.

In addition, it is possible to provide users with systematic and intuitive learning information by providing various UIs for different themes and sub-themes of learning.

Moreover, it is possible to allow users and a service provider to effectively communicate iii with each other by displaying question information on a particular theme of learning, entered by the users, on a screen near the particular theme of learning.

Other features and exemplary embodiments will be apparent from the following detailed description, the drawings, and the claims.

### BRIEF DESCRIPTION OF THE DRAWINGS

FIG. 1 is a block diagram illustrating an electronic device according to an exemplary embodiment of the invention.

FIG. 2 is a flowchart illustrating a process of displaying a learning theme item and a learning sub-theme item by using the electronic device.

FIG. 3 is a flowchart illustrating a process of displaying an additional learning sub-theme item by using the electronic device.

FIGS. 4 to 6 are exemplary views illustrating the processes of FIGS. 2 and 3.

FIG. 7 is a flowchart illustrating a process of displaying a notification window regarding a learning sub-theme item by using the electronic device.

FIGS. 8 and 9 are exemplary views illustrating the process of FIG. 7.

FIG. 10 is a flowchart illustrating a process of displaying a full-screen image by using the electronic device.

FIGS. 11 and 12 are exemplary views illustrating the process of FIG. 10.

FIG. 13 is a flowchart illustrating a process of providing learning information by grade in school or by publisher by using the electronic device.

FIGS. 14 to 16 are exemplary views illustrating the process of FIG. 13.

FIG. 17 is a flowchart illustrating a process of receiving question input information by using the electronic device.

FIG. 18 is an exemplary view illustrating a process of registering question input information to be displayed near a learning sub-theme item through the process of FIG. 17.

FIG. 19 is a flowchart illustrating a process of displaying a mini map of a full-screen image by using the electronic device.

FIGS. 20 and 21 are exemplary views illustrating the process of FIG. 19.

### DETAILED DESCRIPTION OF THE EMBODIMENTS

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The term “learning information item”, as used herein, may denote various objects that can be displayed through a touch screen in the form of user interfaces (UIs) or graphic UIs (GUIs). More specifically, the term “learning information item” may refer to a UI item that guides users to obtain desired learning content, and various learning information items mentioned herein such as learning theme items, learning sub-theme items, and additional learning sub-theme items may be collectively or individually referred to as learning information items.

Learning theme items, learning sub-theme items, and additional learning sub-theme items may be UI items that indicate the theme or unit of study of each learning content. Learning theme items, learning sub-theme items, and additional learning sub-theme items may form a hierarchical structure or a parallel structure with one another. The types of learning information items are not necessarily limited to learning theme items, learning sub-theme items, and additional learning sub-theme items. For example, if four types of UI items are needed to realize the theme or unit of study of particular learning content, an additional UI item that is a superordinate, subordinate, or equal-level concept to learning theme items, learning sub-theme items, or additional learning sub-theme items may be provided and used.

The term “learning content”, as used herein, may denote multimedia content for providing learning information, and may encompass at least one of video lectures, text data, audio information and flash file information.

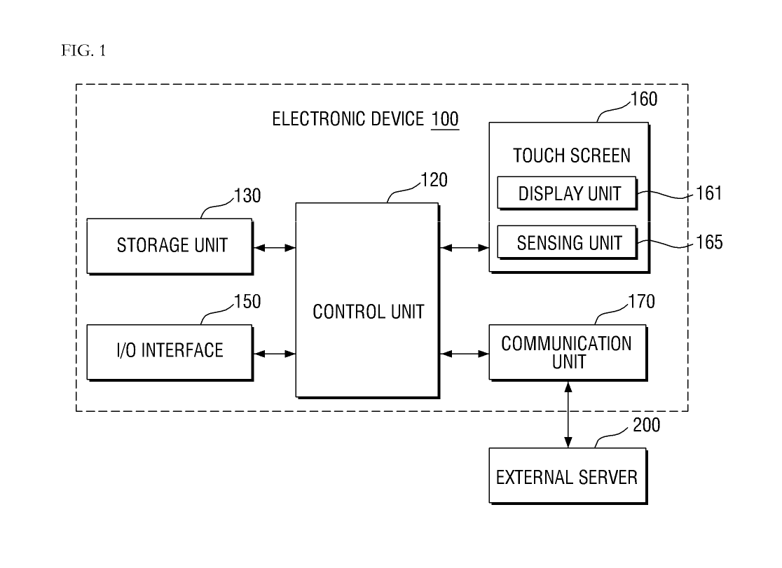

FIG. 1 is a block diagram illustrating an electronic device 100 according to an exemplary embodiment of the invention. Referring to FIG. 1, the electronic device 100 may include a control unit 120, a storage unit 130, an input/output (I/O) interface 150, a touch screen 160, and a communication unit 170. The electronic device 100 may establish a communication connection to an external server 200 via the communication unit 170, and may share various data for providing learning information with the external server 200.

The storage unit 130 may store commands or data received from the control unit 120 or other elements of the electronic device 100. The storage unit 130 may store commands or data generated by the control unit 120 or other elements of the electronic device 100. The storage unit 130 may include programming modules such as, for example, kernels, middleware, application programming interfaces (APIs) or applications. The programming modules may be implemented as software, firmware, hardware or a combination of at least two thereof. For example, the control unit 120 may be implemented as hardware on a processor, a circuit module, a semiconductor chip or a system-on-chip (SOC), software such as an application program, or a combination thereof, i.e., firmware.

In an exemplary embodiment, the storage unit 130 may store at least one data regarding learning information. For example, the storage unit 130 may store one or more learning theme items, one or more learning sub-theme items, one or more additional learning sub-theme items, and learning content. The storage unit 130 may also store size information of an image area in which the learning theme items, the learning sub-theme items, and the additional learning sub-theme items are to be provided. The storage unit 150 may classify the learning theme items, the learning sub-theme items, and the additional learning sub-theme items by grade in school or by publisher and may store the learning theme items, the learning sub-theme items, and the additional learning sub-theme items according to the results of the classification.

The I/O interface 150 may receive numeric data or text data, and may include a plurality of input keys and function keys for setting various functions.

The function keys may include direction keys, side keys and shortcut keys for performing particular functions. The I/O interface 150 may generate a key signal in response to receipt of a key input according to a user setting or in connection with the control of the functions of the electronic device 100, and may transmit the generated key signal to the control unit 120. Examples of the I/O interface 150 may include a panel, a sheet or a digitizer.

The touch screen 160, which is I/O means performing both an input function and a display function at the same time, may include a display unit 161 and a sensing unit 165. The touch screen 160 may display various screen images (for example, a media content play screen, an idle screen, a run screen, etc.) according to an operation of the electronic device 100 through the display unit 161. The touch screen 160 may receive a hand-based input signal or an electronic pen-based input signal through the sensing unit 165 while displaying a screen image through the display unit 161, and may transmit the received input signal to the control unit 120. The control unit 120 may classify the input signal transmitted by the touch screen 160 as a hand-based input signal or a pen-based input signal, may call previously-stored routine information from the storage unit 130 according to the results of the classification, and may perform a function corresponding to the input signal transmitted by the touch screen 160.

The touch screen 160 may be implemented as a liquid crystal display (LCD), an organic light-emitting diode (OLED), etc., and may be included in input means (for example, the I/O interface 150).

In an exemplary embodiment, the touch screen 160 may display various UI items in connection with the providing of learning information, and may receive a user selection of the various UI items from the user.

The display unit 161 may display or output information processed by the electronic device 100. For example, the display unit 161 may display learning information such as a learning theme item, a learning sub-theme item or an additional learning sub-theme item as a UI or a GUI.

The sensing unit 165 may be formed by coupling a first touch panel for recognizing an ordinary touch input or a proximity touch input made by a finger of a user and a second touch panel for recognizing an ordinary touch input or a proximity touch input made by an electronic pen. The first and second touch panels may be integrally formed. The first and second touch panels may be implemented as capacitive, resistive, ultrasonic, infrared or electromagnetic induction touch panels. The term “touch input”, as used herein, means an input recognized when an input tool (for example, an electronic pen, a finger, etc.) contacts the surface of the touch screen 160, and the term “proximity touch input” means an input recognized when the input tool approaches within a predetermine distance of the touch screen 160, i.e., hovers over the touch screen 160.

The sensing unit 165 may sense a touch or non-touch input (such as, for example, a touch-based long press input, a touch-based short press input, a single touch input, a multi-touch input, a touch-based gesture input, a hovering input, etc.).

The communication unit 170 may support a wireless communication function of the electronic device 100.

For example, the communication unit 170 may include a radio frequency (RF) transmitter, which up-converts the frequency of, and amplifies, a wireless signal transmitted thereto. The communication unit 170 may also include an RF receiver, which low-noise-amplifies, and down-converts the frequency of, a wireless signal transmitted thereto. In response to the electronic device 100 supporting a near-field wireless communication function, the communication unit 170 may include a Wi-Fi communication module, a Bluetooth communication module, a ZigBee communication module, an Ultra Wideband (UWB) communication module, a Near Field Communication (NFC) module, etc. The communication unit 170 may be connected to at least one other electronic device or the external server 200 connected to the electronic device 100 via a network.

In an exemplary embodiment, the communication unit 170 may establish a communication connection to the external server 200 and may share various data regarding learning information with the external server 200. Also, the communication unit 170 may transmit question input information received from the user to the external server 200, may receive a feedback on the question input information from the external server 200 and may transmit the received feedback to the control unit 120 or the storage unit 130.

The control unit 120 may control the overall operation of the electronic device 100 and the flow of signals between the elements of the electronic device 100 and may perform a data processing function of processing data. The control unit 120 may be implemented as a central processing unit (CPU) or an application processor (AP). The control unit 120 may control the elements of the electronic device 100 so as for the electronic device 100 to receive a user selection of learning information and to provide learning information through various UIs.

In an exemplary embodiment, the control unit 120 may display at least one learning sub-theme item related to a learning theme item through the touch screen 160 by mapping the learning sub-theme item to the learning theme item. Thereafter, the control unit 120 may receive a predefined user input for the learning sub-theme item. The control unit 120 may control the touch screen 160 to display a notification window including at least one of image data and text data regarding the learning sub-theme item according to the received predefined user input.

In an exemplary embodiment, the control unit 120 may control the touch screen 160 to display the notification window in such a manner that the notification window can slide from one area on the touch screen 160 in at least one direction. In this exemplary embodiment, the notification window may include image data regarding the learning sub-theme item, a description of the image data, a summary of the learning sub-theme item, and a summary of any additional learning sub-theme item related to the learning sub-theme item.

In an exemplary embodiment, the control unit 120 may receive a user input for a particular UI item included in the notification window and may control the touch screen 160 to display any additional learning sub-theme item related to the learning sub-theme item according to the received user input.

In an exemplary embodiment, the control unit 120 may receive a user input for the additional learning sub-theme item. The control unit 120 may control the touch screen 160 to provide learning content corresponding to the additional learning sub-theme item according to the received user input.

In an exemplary embodiment, the control unit 120 may control the touch screen 160 to display a full-screen image, in which all learning theme items, all learning sub-theme items, and all additional learning sub-theme items included in particular learning information are displayed at a predetermined reduced scale, according to a predefined user input.

In an exemplary embodiment, the control unit 120 may control the touch screen 160 to scale up or down the full-screen image according to a drag input received from the user. Also, the control unit 120 may receive a pinch zoom input from the user and may control a screen image (for example, the full-screen image) provided through the touch screen 160 according to the pinch zoom input. For this, the control unit 120 may be configured to recognize a drag input or pinch zoom input through an input tool such as a finger of the user or a stylus.

In an exemplary embodiment, the control unit 120 may display a UI menu including grade information or publisher information through the touch screen 160 in response to receipt of a user input for displaying the UI menu. Also, the control unit 120 may receive a user selection of the grade information or the publisher information from the user through the touch screen 160 and may control the touch screen 160 to update and display a learning theme item and at least one learning sub-theme item related to the learning theme item according to the received user selection.

In an exemplary embodiment, the control unit 120 may generate a mini map by scaling down the full-screen image at a predetermined rate, and may control the touch screen 160 to display the mini map on at least part of the screen of the touch screen 160.

In an exemplary embodiment, the control unit 120 may generate an indicator, which indicates part of the full-screen image currently being displayed on the touch screen 160. In this exemplary embodiment, the indicator may be displayed to be included in the mini map.

The control unit 120 may display the indicator through the touch screen 160, but the invention is not limited thereto. That is, alternatively, the control unit 120 may generate the indicator along with the mini map so that the indicator can be included in the mini map. Still alternatively, the control unit 120 may generate the indicator and the mini map separately, and may merge the indicator into the mini map or lay the indicator over the mini map in the process of displaying the mini map on the touch screen 160.

In an exemplary embodiment, the control unit 120 may display at least one learning sub-theme item related to a learning theme item through the touch screen 160 by mapping the learning sub-theme item to the learning theme item. The control unit 120 may receive question input information regarding at least one of the learning theme item and the learning sub-theme item through the touch screen 160. Then, the control unit 120 may generate a UI item including at least part of the question input information and may control the touch screen 160 to display the UI item near the learning theme item or the learning sub-theme item.

In an exemplary embodiment, the control unit 120 may receive a plurality of question input information for at least one of the learning theme item and the learning sub-theme item. In this exemplary embodiment, the control unit 120 may control the touch screen 160 to display the number of the plurality of question input information near the UI item.

The external server 200 may be a sub-system relaying a service provider who provides learning information and the user of the electronic device 100 who is provided with the learning information and providing an intensive processing function. The external server 200 may be implemented as a computer or software capable of transmitting data to or receiving data from the electronic device 100 by communicating with the electronic device 100. Although not illustrated, the external server 200 may include a memory, a communication interface, an I/O interface, a display unit and a processing unit which controls the flow of signals between the elements of the external server 200.

The electronic device 100 may receive a user input through the touch screen 160, but the invention is not limited thereto. That is, the electronic device 100 may be equipped with a physical keypad and may display data regarding learning information according to a user input (for example, an input event). For this, a learning information providing function mapped to the physical keypad may be stored in advance in the storage unit 130.

Although not illustrated in FIG. 1, the electronic device 100 may also include an audio processing unit, a camera unit, a power management unit or a battery. For example, the electronic device 100 may output audio data regarding learning information through a speaker included in the audio processing unit or may receive and recognize a user selection of learning information through a microphone included in the audio processing unit.

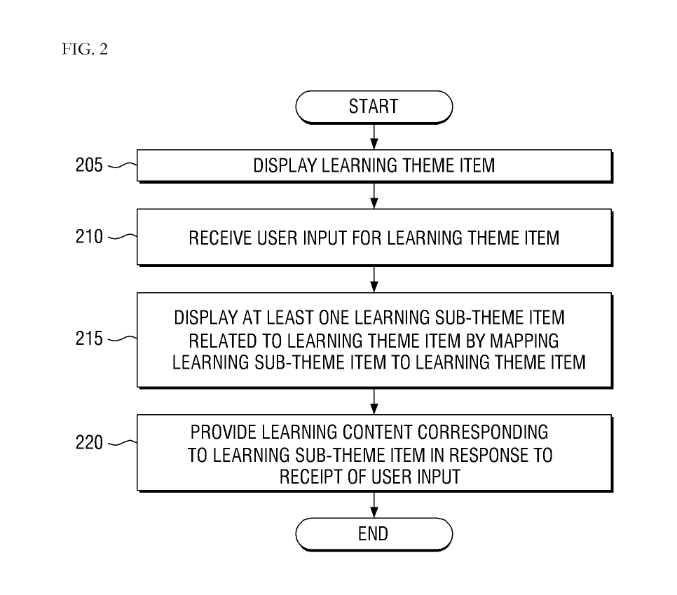

FIG. 2 is a flowchart illustrating a process of displaying a learning theme item and a learning sub-theme item by using the electronic device 100.

Referring to FIG. 2, in an exemplary embodiment, in 205, the electronic device 100 may display a learning theme item. For example, the control unit 120 may control the storage unit 130 and the touch screen 160 to call a learning theme item stored in the storage unit 130 and display the called learning theme item on the touch screen 160. The called learning theme item may be one selected by a user from among a plurality of learning theme items displayed on the touch screen 160, and the electronic device 100 may display a particular learning theme item according to a default setting in response to receipt of a user input, the driving of a system, or the execution of an application.

In an exemplary embodiment, in 210, the electronic device 10 may receive a user input for the learning theme item. For example, the control unit 120 may receive a touch input for the learning theme item through the touch screen 160.

In an exemplary embodiment, in 215, the electronic device 100 may display at least one learning sub-theme item related to the learning theme item by mapping the learning sub-theme item to the learning theme item. For example, the electronic device 100 may display the learning sub-theme item in response to receipt of a touch input for the learning theme item. In this example, the control unit 100 may control the touch screen 160 to display the learning sub-theme item near the learning theme item.

In an exemplary embodiment, the electronic device 100 may arrange the learning sub-theme item in at least part of an imaginary circular trajectory drawn around the learning theme item. In this exemplary embodiment, the electronic device 100 may also display a connecting line that connects the learning theme item and the learning sub-theme item. Accordingly, the user may identify from the connecting line that the learning theme item and the learning sub-theme item are mapped.

In an exemplary embodiment, in 220, the electronic device 100 may provide learning content corresponding to the learning sub-theme item in response to receipt of a user input for the learning sub-theme item.

For example, in response to receipt of a touch input for the learning sub-theme item, the control unit 120 may control the elements of the electronic device 100 to provide learning content related to the learning sub-theme item. In this example, the electronic device 100 may provide the learning content in the form of multimedia content such as audios, images, videos, etc.

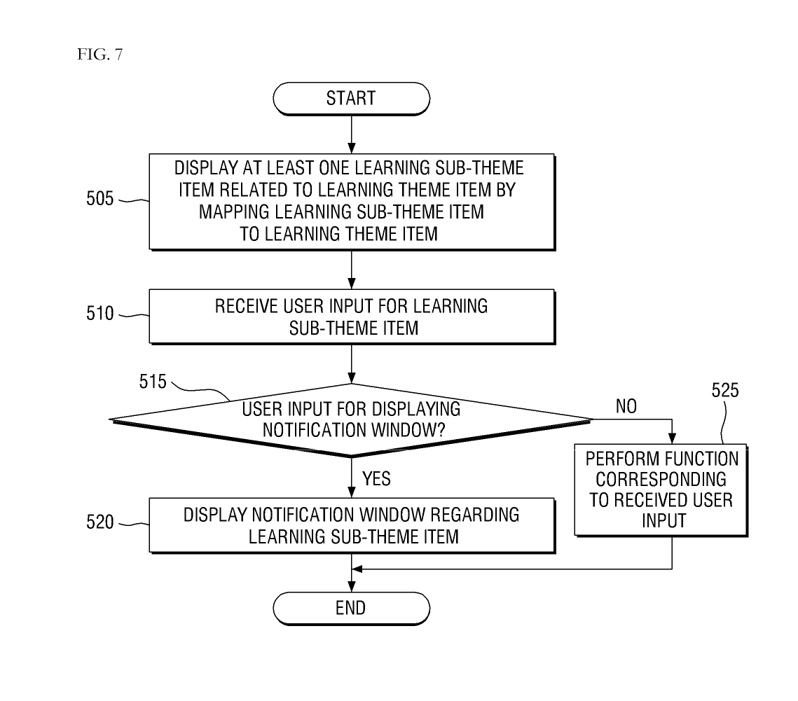

In an exemplary embodiment, the electronic device 100 may not only provide learning content related to the learning sub-theme item, but also display a notification window regarding the learning sub-theme item, according to a user input. This exemplary embodiment will be described later in detail with reference to FIG. 7.

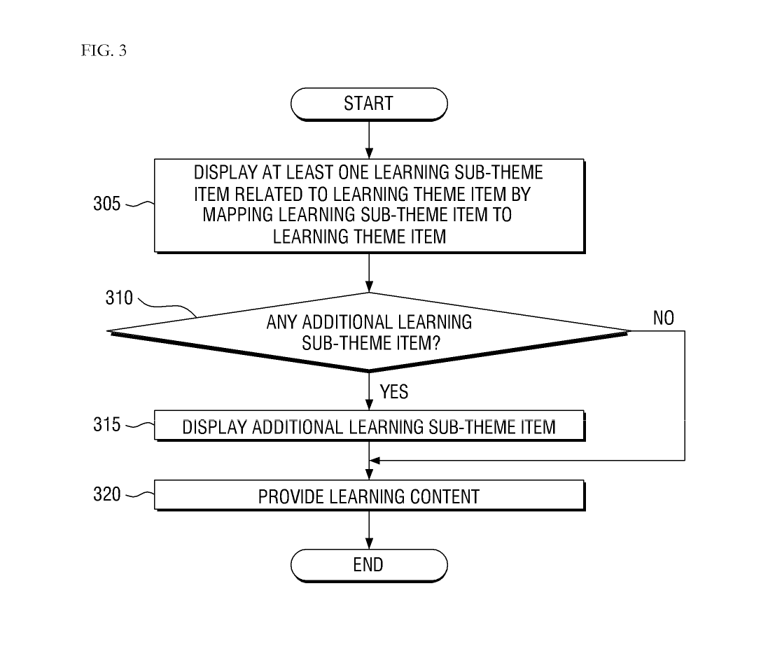

FIG. 3 is a flowchart illustrating a process of displaying an additional learning sub-theme item by using the electronic device 100. Descriptions of steps that have already been described with reference to FIG. 2 may be omitted here.

Referring to FIG. 3, in an exemplary embodiment, in 305, the electronic device 100 may display a learning theme item and a learning sub-theme item by mapping the learning sub-theme item to the learning theme item. For example, the control unit 120 may display a learning theme item on the touch screen 160 and may display at least one learning sub-theme item related to the learning theme item on the touch screen 160 in response to receipt of a touch input for the learning theme item. As mentioned above, the control unit 120 may display the learning sub-theme item by mapping the learning theme item and the learning sub-theme item, and may also display a connecting line to indicate the mapping between the learning theme item and the learning sub-theme item.

In an exemplary embodiment, in 310, the electronic device 100 may determine whether there is any additional learning sub-theme related to the learning theme item. For example, the control unit 120 may search the storage unit 130 for any additional learning sub-theme related to the learning theme item. The additional learning sub-theme item may represent a theme item subordinate to the theme of the learning sub-theme item.

In an exemplary embodiment, in 320, in response to there being no additional learning sub-theme item related to the learning sub-theme item, the electronic device 100 may provide learning content corresponding to the learning sub-theme item. In a case when there is no additional learning sub-theme item, it means that the learning sub-theme item is an item capable of providing learning content in response to receipt of a user input. For example, the control unit 120 may execute learning content corresponding to the learning sub-theme item according to a touch input for the learning sub-theme item.

In an exemplary embodiment, in 315, in response to there existing at least one additional learning sub-theme item related to the learning sub-theme item, the electronic device 100 may display the additional learning sub-theme item. For example, the control unit 120 may display at least one additional learning sub-theme item related to the learning sub-theme item on the touch screen 160. The electronic device 100 may arrange the additional learning sub-theme item in at least part of an imaginary circular trajectory drawn around the learning sub-theme item in the same method used to map the learning sub-theme item to the learning theme item. The electronic device 100 may also display a connecting line that connects the additional learning sub-theme item and the learning sub-theme item. Accordingly, the user may identify from the connecting line that the additional learning sub-theme item and the learning sub-theme item are mapped.

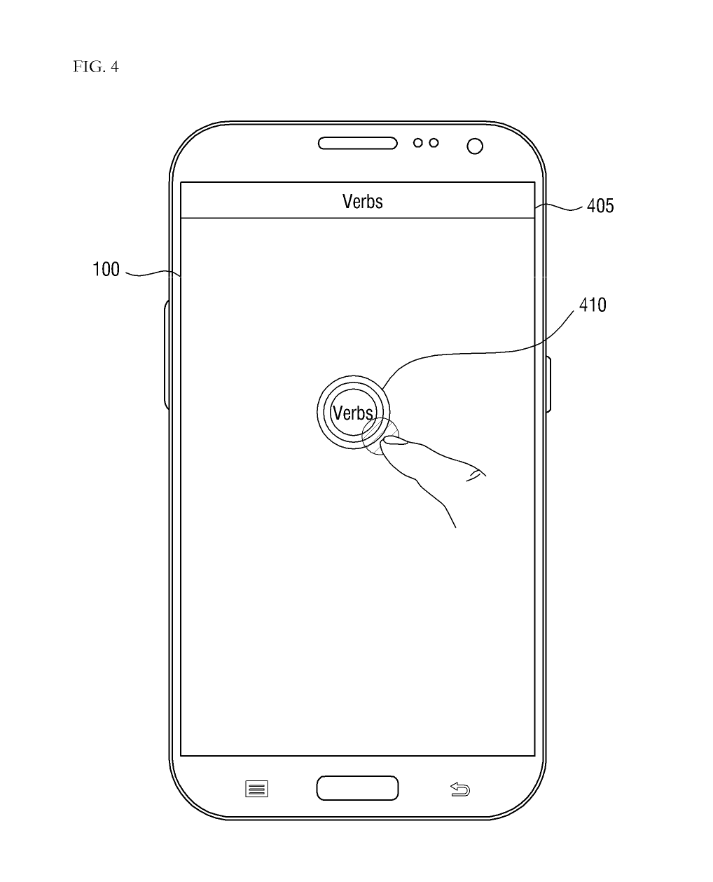

FIGS. 4 to 6 are exemplary views illustrating the processes of FIGS. 2 and 3.

FIG. 4 illustrates a state in which the electronic device 100 displays a learning theme item 410 on the touch screen 160. Referring to FIG. 4, the learning theme item 410 is displayed as a circular UI item, and the word “Verbs”, which represents the theme of the learning theme item 410, is displayed inside the UI item. A learning theme window 405 is displayed at an upper part of the touch screen 160, and indicates that that the learning theme item 410 currently being displayed on the touch screen 160 corresponds to “Verbs”-related learning information. The electronic device 100 may receive a user input (for example, a touch input) for the learning theme item 410.

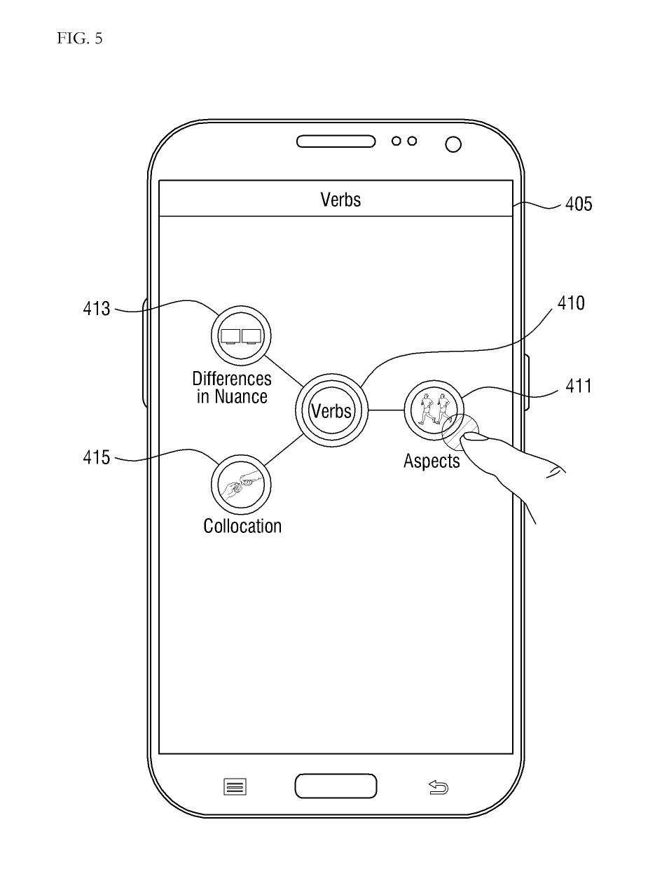

FIG. 5 illustrates a state in which the electronic device 100 displays three learning sub-theme items 411, 413, and 415 related to the learning theme item 410 in response to receipt of a touch input for the learning theme item 410. Referring to FIG. 5, the learning sub-theme items 411, 413, and 415 represent “Aspects”, “Differences in Nuance”, and “Collocation”, respectively, which are related to the theme of the learning theme item 410, i.e., “Verbs”, and symbol images are respectively displayed in the learning sub-theme items 411, 413, and 415 to indicate the content of the learning sub-theme items 411, 413, and 415. The learning sub-theme items 411, 413, and 415 are arranged within an imaginary circular trajectory drawn around the learning theme item 410, and are connected to the learning theme item 410 by connecting lines, but the invention is not limited thereto. That is, the learning sub-theme items 411, 413, and 415 may be arranged at various locations other than that set forth herein. The electronic device 100 may receive a touch input for the learning sub-theme item 411.

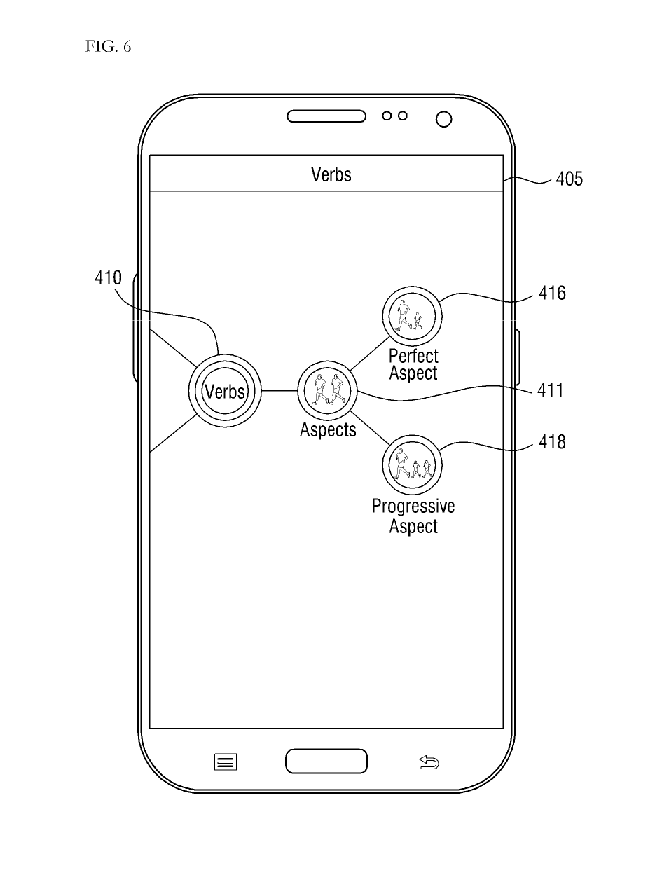

FIG. 6 illustrates a state in which the electronic device 100 displays two additional learning sub-theme items 416 and 418 related to the learning sub-theme item 411 in response to receipt of a touch input for the learning sub-theme item 411. Referring to FIG. 6, the additional learning sub-theme items 416 and 418 represent “Perfect Aspect” and “Progressive Aspect”, respectively, which are related to the theme of the learning sub-theme item 411, i.e., “Aspects”, and symbol images are respectively displayed in the additional learning sub-theme items 416 and 418 to indicate the content of the additional learning sub-theme items 416 and 418. As analogously illustrated in FIG. 5, the additional learning sub-theme items 416 and 418 are arranged within an imaginary circular trajectory drawn around the learning sub-theme item 411, and are connected to the learning sub-theme item 411 by connecting lines, but the invention is not limited thereto. That is, the additional learning sub-theme items 416 and 418 may be arranged at various locations other than that set forth herein.

In response to receipt of a selection of the learning sub-theme item 411 of FIG. 5, the control unit 120 may control the touch screen 160 to display the learning sub-theme item 411 at the center of the touch screen 160, as illustrated in FIG. 6.

The selected learning sub-theme item 411 may be displayed differently from other learning sub-theme items in color, shade, size, shape or the number of lines drawn therearound. Accordingly, the user can effectively and intuitively identify the additional learning theme items 416 and 418 of the selected learning sub-theme item 411. Although not illustrated, the electronic device 100 may display any subordinate learning information items to the additional learning sub-theme items 416 and 418 in response to receipt of a user input (for example, a touch input) for the additional learning sub-theme items 416 and 418. In response to there being no subordinate learning theme items to the additional learning sub-theme items 416 and 418, the electronic device 100 may provide learning content corresponding to the additional learning sub-theme items 416 and 418 according to a user input for the additional learning sub-theme items 416 and 418.

FIG. 7 is a flowchart illustrating a process of displaying a notification window regarding a learning sub-theme item by using the electronic device 100.

Referring to FIG. 7, in an exemplary embodiment, in 505, the electronic device 100 may display a learning theme item and a learning sub-theme item by mapping the learning sub-theme item to the learning theme item. For example, the control unit 120 may display a learning theme item on the touch screen 160 and may display at least one learning sub-theme item related to the learning theme item on the touch screen 160 in response to receipt of a touch input for the learning theme item. As mentioned above, the control unit 120 may display the learning theme item and the learning sub-theme item by mapping the learning sub-theme item to the learning theme item, and may display a connecting line to connect the learning theme item and the learning sub-theme item.

In an exemplary embodiment, in 510, the electronic device 100 may receive a user input for the learning sub-theme item.

In an exemplary embodiment, in 515, the electronic device 100 may determine whether the received user input is for displaying a notification window regarding the learning sub-theme item. For example, the control unit 120 may determine whether the received user input is a predefined user input for displaying the notification window. The predefined user input may be a touch-and-hold input or an electronic pen input, but the invention is not limited thereto. The control unit 120 may receive a user setting for setting the predefined user input. Alternatively, the predefined user input may be set by the designer of a relevant application or program.

In an exemplary embodiment, the notification window may include a description of a symbol image corresponding to a sub-theme and the title, the content and a summary of a unit of study corresponding to the sub-theme.

In an exemplary embodiment, in 520, in response to the received user input being the predefined user input, the electronic device 100 may display the notification window. For example, in response to receipt of the predefined user input, the control unit 120 may control the touch screen 160 to display the notification window in such a manner that the notification window can slide from one area on the touch screen 160 in at least one direction.

In an exemplary embodiment, in response to receipt of the predefined user input, the control unit 120 may control the touch screen 160 to display a notification window including image data and text data related to the theme of the learning sub-theme item. The control unit 120 may also control the touch screen 160 to display a notification window including multimedia content such videos or audios.

In an exemplary embodiment, in response to there existing at least one additional learning sub-theme item related to the learning sub-theme item, the control unit 120 may display the notification window first and may then display the additional learning sub-theme item. For example, in response to receipt of a touch input for the learning sub-theme item, the electronic device 100 may display the notification window. Then, in response to receipt of an additional user input (for example, an input of a “Continue” button on the notification window), the electronic device 10 may display the additional learning sub-theme item.

In an exemplary embodiment, in 525, in response to the received user input not being the predefined user input, the electronic device 100 may perform a function corresponding to the received user input.

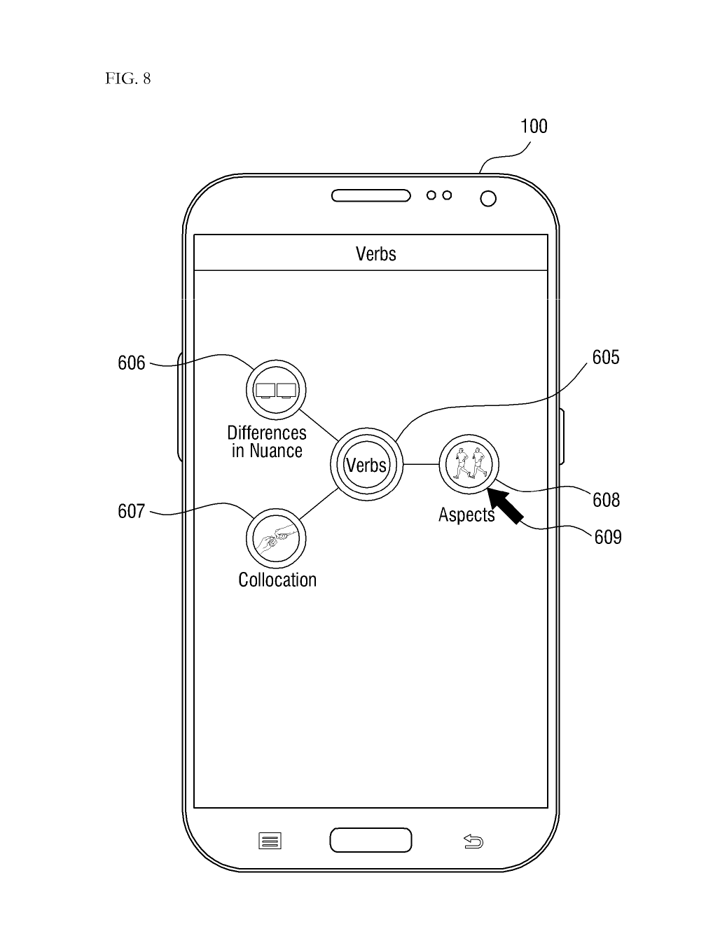

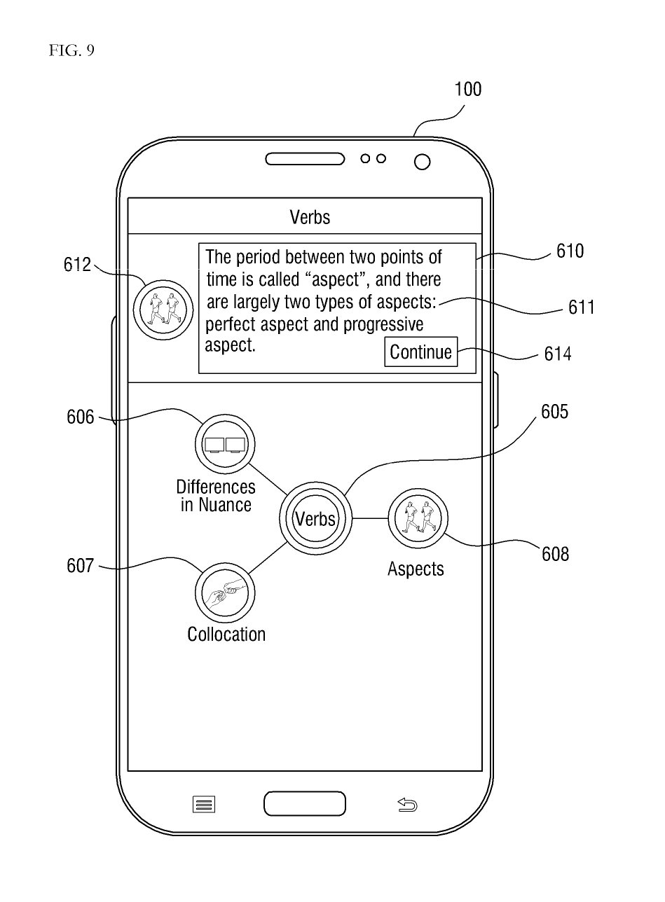

FIGS. 8 and 9 are exemplary views illustrating the process of FIG. 7.

Referring to FIG. 8, the electronic device 100 displays a learning theme item 605 and three learning sub-theme items 606, 607, and 608 related to the learning theme item 605 on the touch screen 160. The learning theme item 605 and the learning sub-theme items 606, 607, and 608 are displayed as circular UI icons, and each include text or image data therein. The electronic device 100 receives a user input for the learning sub-theme item 608 from the user, as indicated by an arrow 609.

FIG. 9 illustrates a state in which the electronic device 100 displays a notification window 610 regarding the learning sub-theme item 608 in response to receipt of a user input for the learning sub-theme item 608. As mentioned above, the electronic device 100 may display the notification window 610 in response to receipt of for example, a predefined user input for displaying the notification window 610. Alternatively, the electronic device 100 may display the notification window 610 in response to a simple touch input for the learning sub-theme item 608 without the need to set the predefined user input in advance. In response to there existing at least one additional learning sub-theme item related to the learning sub-theme item 608, the electronic device 100 may display the notification window 610 first and may then display the additional learning sub-theme item in response to a “Continue” icon 614 in the notification window 610 being touched.

The notification window 610 may include text data 611 and image data 612. The image data 612 corresponds to a UI image of the learning sub-theme item 608, and the text data 611 corresponds to data regarding the learning sub-theme item 608. As illustrated in FIG. 9, the text data 611 may include a description of the image data 612 and a summary of the learning sub-theme item 608. The text data 611 may also include a description of any additional learning sub-theme item related to the learning sub-theme item 608. For example, the user may identify from the text data 611 that there exist additional learning sub-theme items related to the learning sub-theme item 608, i.e., “Perfect Aspect” and “Progressive Aspect”.

As mentioned above, the electronic device 100 displays the notification window 610. Accordingly, the user can be provided with brief information about the learning sub-theme item 608. Thus, learning information can be effectively and intuitively provided to the user.

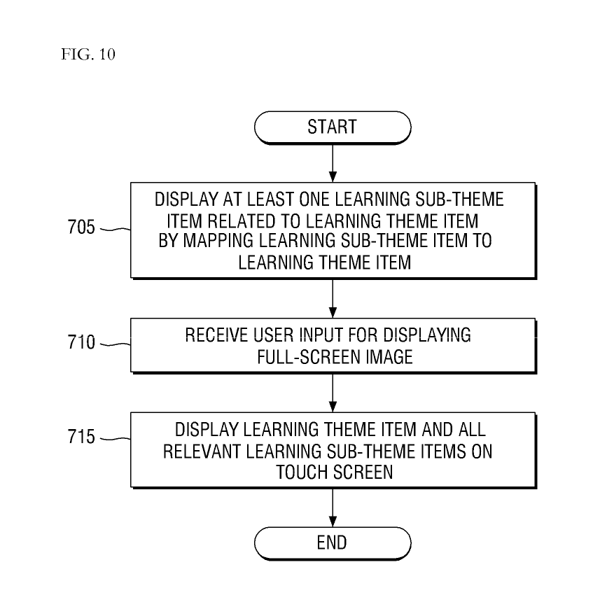

FIG. 10 is a flowchart illustrating a process of displaying a full-screen image by using the electronic device.

Referring to FIG. 10, in an exemplary embodiment, in 705, the electronic device 100 may display a learning theme item and a learning sub-theme item by mapping the learning sub-theme item to the learning theme item. For example, the control unit 120 may display a learning theme item on the touch screen 160 and may display at least one learning sub-theme item related to the learning theme item on the touch screen 160 in response to receipt of a touch input for the learning theme item. As mentioned above, the control unit 120 may display the learning theme item and the learning sub-theme item by mapping the learning sub-theme item to the learning theme item, and may display a connecting line to connect the learning theme item and the learning sub-theme item.

In an exemplary embodiment, in 710, the electronic device 100 may receive a predefined user input for displaying a full-screen image. For example, the control unit 120 may display a UI icon for displaying a full-screen image in one area on the touch screen 160, and may receive a user input for the UI icon from the user. The control unit 120 may identify the received user input as being for displaying a full-screen image.

In an exemplary embodiment, in 715, the electronic device 100 may display both the learning theme item and the learning sub-theme item on the touch screen 160.

For example, in response to receipt of a user input for displaying a full-screen image, the control unit 120 may display both the learning theme item and the learning sub-theme item on the touch screen 160. In response to there existing at least one additional learning sub-theme item related to the learning sub-theme item, the control unit 120 may control the touch screen to display all the learning theme item, the learning sub-theme item, and the additional learning sub-theme item on the touch screen 160.

In an exemplary embodiment, the electronic device 100 may scale down the learning theme item, the learning sub-theme item, and the additional learning sub-theme item at a predetermined rate such that the learning theme item, the learning sub-theme item, and the additional learning sub-theme item can all be displayed as a whole on the touch screen 160. For example, the control unit 120 may scale down an image area including the learning theme item, the learning sub-theme item, and the additional learning sub-theme item at a predetermined rate in consideration of screen size information of the touch screen 160. For this, the control unit 120 may have the screen size information of the touch screen 160 and size information of the image area stored in the storage unit 130 in advance and may call the stored information from the storage unit 130.

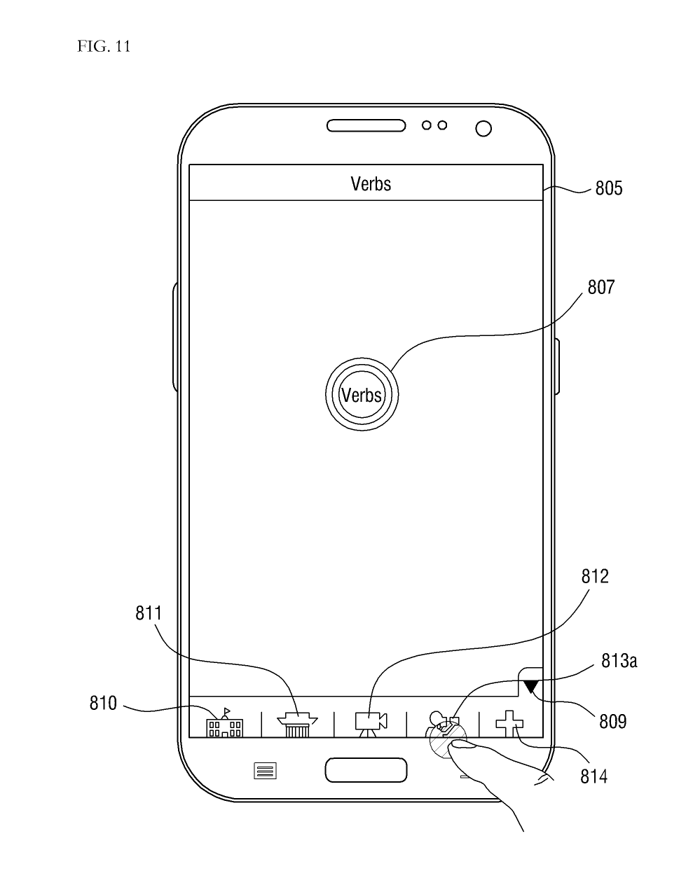

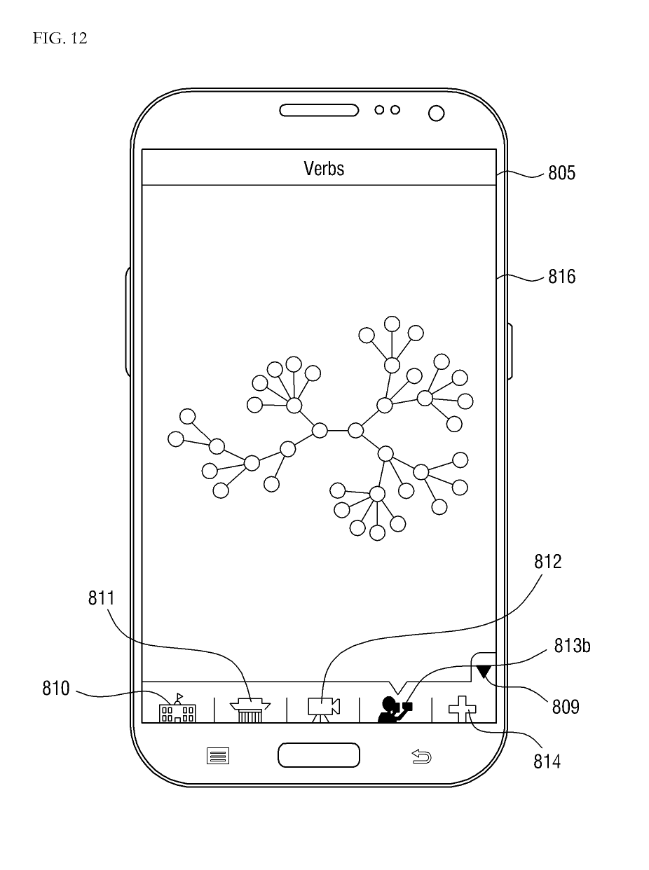

FIGS. 11 and 12 are exemplary views illustrating the process of FIG. 10.

FIG. 11 illustrates a state of receiving a user input for displaying a full-screen image. Referring to FIG. 11, the electronic device 100 displays a learning theme window 805, a learning theme item 807, and a UI menu window 809 through the touch screen 160. The learning theme window 805 and the learning theme item 807 are the same as their respective counterparts of FIG. 4, and thus, detailed descriptions thereof will be omitted.

The UI menu window 809 includes UI menu icons 810, 811, 812, 813a, and 814. The control unit 120 may perform a predefined function in response to receipt of a user input for each of the menu icons UI menu icons 810, 811, 812, 813a, and 814. In an exemplary embodiment, the electronic device 100 may receive a touch input for the UI menu icon 813a, which is for displaying a full-screen image.

FIG. 12 illustrates a state of displaying a full-screen image 816 in response to receipt of a touch input for the UI menu icon 813a from the user. Referring to FIG. 12, although not specifically illustrated, the full-screen image 816 may include a learning theme item, at least one learning sub-theme item related to the learning theme item, and at least one additional learning sub-theme item related to the learning sub-theme item. To indicate that the full-screen image 816 is currently being displayed in response to receipt of a user input for the UI menu icon 813a, the electronic device 100 may display a UI menu icon 813b by changing the color of the UI menu icon 813a.

As mentioned above, the electronic device 100 displays the full-screen image in response to receipt of a predefined user input. Accordingly, the user can easily identify a preview image of learning information. Thus, the user can view an entire learning information structure and can be assisted to set up a learning schedule.

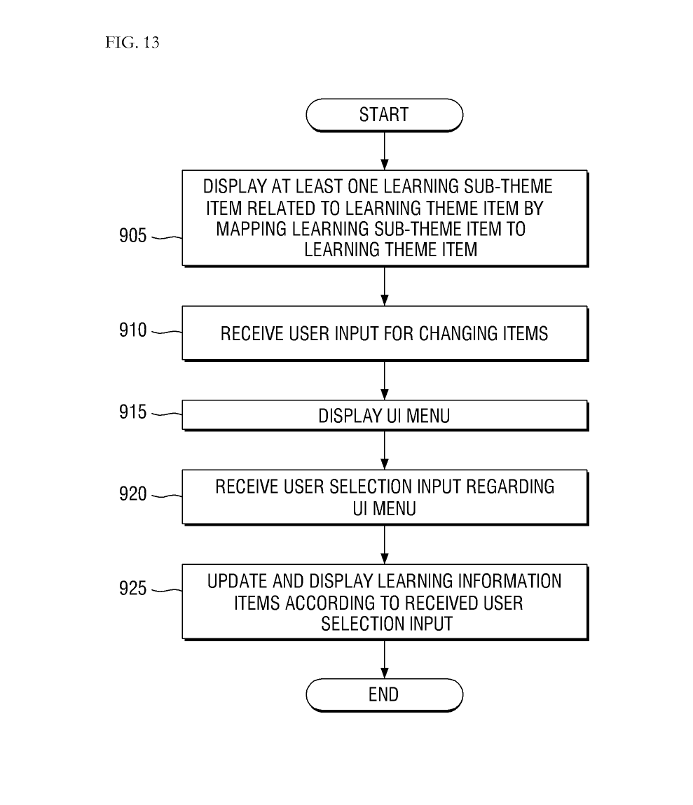

FIG. 13 is a flowchart illustrating a process of providing learning information by grade in school or by publisher by using the electronic device 100.

Referring to FIG. 13, in an exemplary embodiment, in 905, the electronic device 100 may display a learning theme item and a learning sub-theme item by mapping the learning sub-theme item to the learning theme item. For example, the control unit 120 may display a learning theme item on the touch screen 160 and may display at least one learning sub-theme item related to the learning theme item on the touch screen 160 in response to receipt of a touch input for the learning theme item. As mentioned above, the control unit 120 may display the learning sub-theme item by mapping the learning theme item and the learning sub-theme item, and may also display a connecting line to indicate the mapping between the learning theme item and the learning sub-theme item.

In an exemplary embodiment, in 910, the electronic device 100 may receive a user input for changing items. For example, the control unit 120 may receive a user input for changing the displaying of the learning theme item and the learning sub-theme item on the touch screen 160.

In an exemplary embodiment, in 915, the electronic device 100 may display a UI menu. For example, the control unit 120 may control the touch screen 160 to display a UI menu for displaying grade information or publisher information. However, the grade information and the publisher information are exemplary, and the invention is not limited thereto. That is, the UI menu may include selection options for changing the display of the learning theme item and the learning sub-theme item according to the user's level of difficulty for learning and the frequency of the themes of the learning theme item and the learning sub-theme item in actual tests. The publisher information may include information on various publishers in, for example, the public education sector or the private education sector, that provide learning information.

In an exemplary embodiment, in 920, the electronic device 100 may receive a user selection input regarding the UI menu. For example, the control unit 120 may control the touch screen 160 to display at least one grade information and at least one checkbox icon for the respective grade information and to receive a user selection input regarding the grade information and/or the checkbox icon.

In an exemplary embodiment, in 925, the electronic device 100 may update and display learning information items according to the received user selection input. For example, the control unit 120 may update and display at least one of a learning theme item, a learning sub-theme item and an additional learning sub-theme item that corresponds to a value set by the received user selection input. For this, the electronic device 100 may store a learning theme item, one or more learning sub-theme items, and one or more additional learning sub-theme items that are provided by grade in school or by publisher in the storage unit 130 in advance.

Also, learning information-providing items that are provided by grade in school or by publisher may be stored in the storage unit 130 at the time of the manufacture of the electronic device 100 or at the time of the implementation of a learning information-providing application. The control unit 120 may control the storage unit 130 and the touch screen 160 to receive a user selection input regarding the UI menu and to call and display an item relevant to the received user selection input.

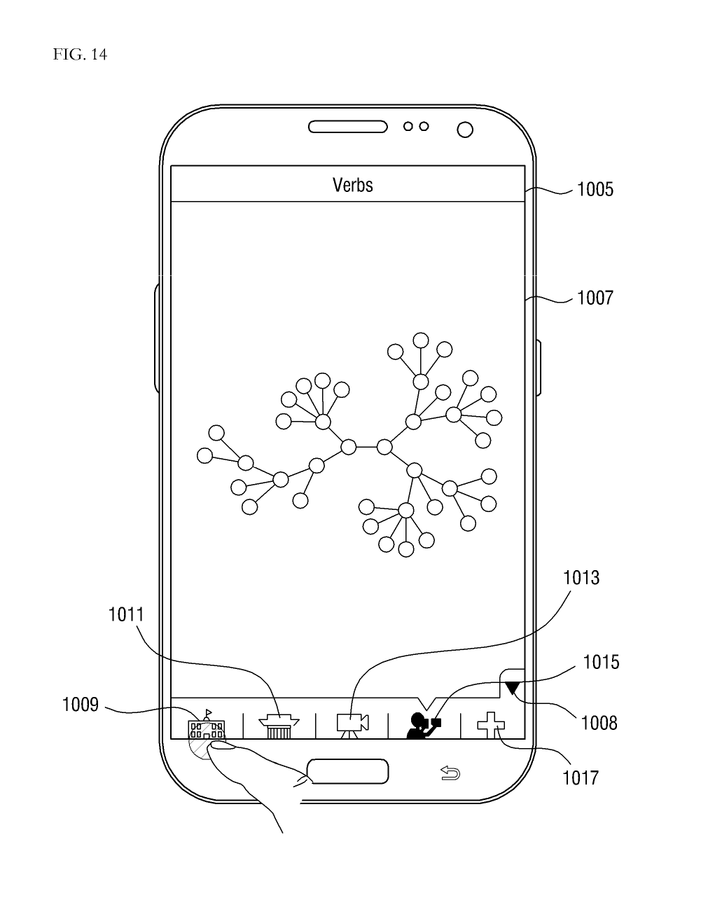

FIGS. 14 to 16 are exemplary views illustrating the process of FIG. 13.

FIG. 14 illustrates a full-screen image 1007 of the electronic device 100.

Referring to FIG. 14, the electronic device 100 displays a learning theme window 1005, the full-screen image 1007, and a UI menu window 1008 through the touch screen 160. The UI menu window 1008 includes UI menu icons 1009, 1011, 1013, 1015, and 1017. The control unit 120 may perform a predefined function in response to receipt of a user input for each of the UI menu icons 1009, 1011, 1013, 1015, and 1017. In an exemplary embodiment, the electronic device 100 may receive a touch input for the UI menu icon 1009 from the user for changing the display of a learning theme item, a learning sub-theme item and an additional learning sub-theme item.

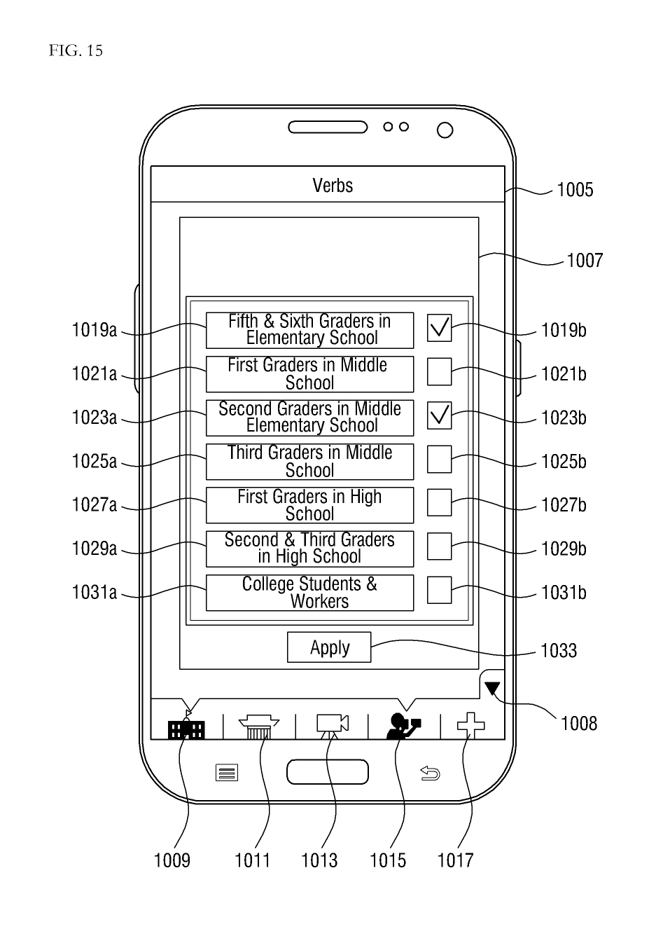

FIG. 15 illustrates a state in which the electronic device 100 displays a grade-specific UI menu 1007 in response to receipt of a user input for the UI menu icon 1009. In FIG. 15, the grade-specific UI menu 1007 is displayed, but the invention is not limited thereto. That is, alternatively, the electronic device 100 may provide a publisher-specific UI menu.

The grade-specific UI menu 1007 includes grade information icons 1019a, 1021a, 1023a, 1025a, 1027a, 1029a, and 1031a, checkbox icons 1019b, 1021b, 1023b, 1025b, 1027b, 1029b, and 1031b for the grade information icons 1019a, 1021a, 1023a, 1025a, 1027a, 1029a, and 1031a, respectively, and an “Apply” icon 1033. The grade information icons 1019a, 1021a, 1023a, 1025a, 1027a, 1029a, and 1031a represent various grades in school and workers, and the checkbox icons 1019b, 1021b, 1023b, 1025b, 1027b, 1029b, and 1031b may be selectively checked by the user so as for the user to be provided with learning information according to his or her grade information. For example, the user may check the checkbox icons 1019b for fifth and sixth grades in elementary school and the checkbox icon 1023 for second grade in middle school, and may then input the “Apply” icon 1033.

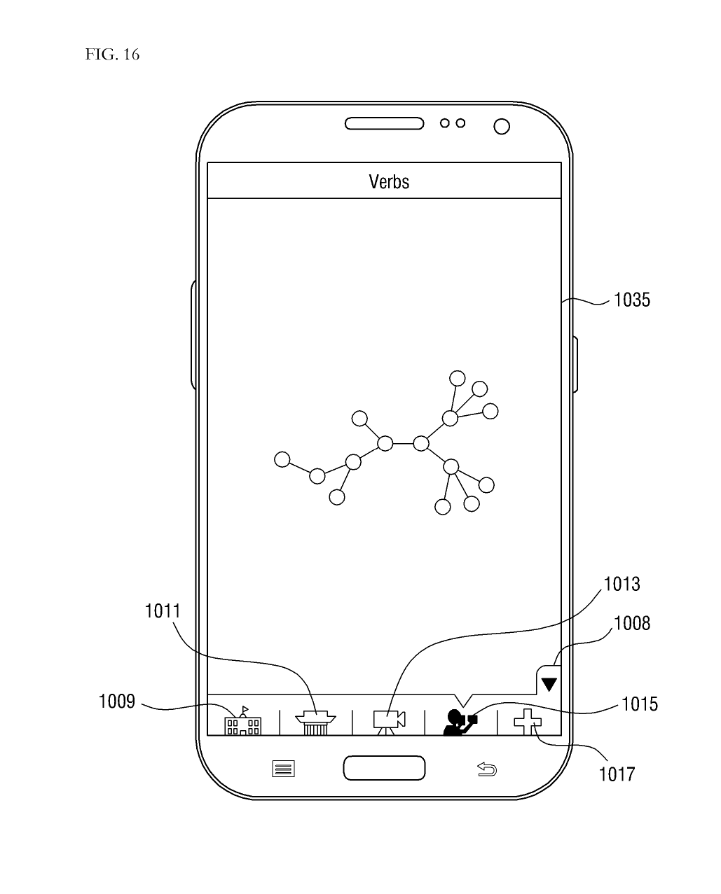

Referring to FIG. 16, an updated full-screen image 1035 including learning information items is displayed according to the user selections of FIG. 15. The electronic device 100 displays learning information items that are updated according to the user selections of FIG. 15 through the touch screen 160. The updated full-screen image 1035 is a screen image set to provide learning information to fifth and sixth graders in elementary school and second graders in middle school.

As mentioned above, learning information can be provided differently by grade in school or by publisher, and thus, the user can be provided with learning information according to his or her level of knowledge and/or grade in school.

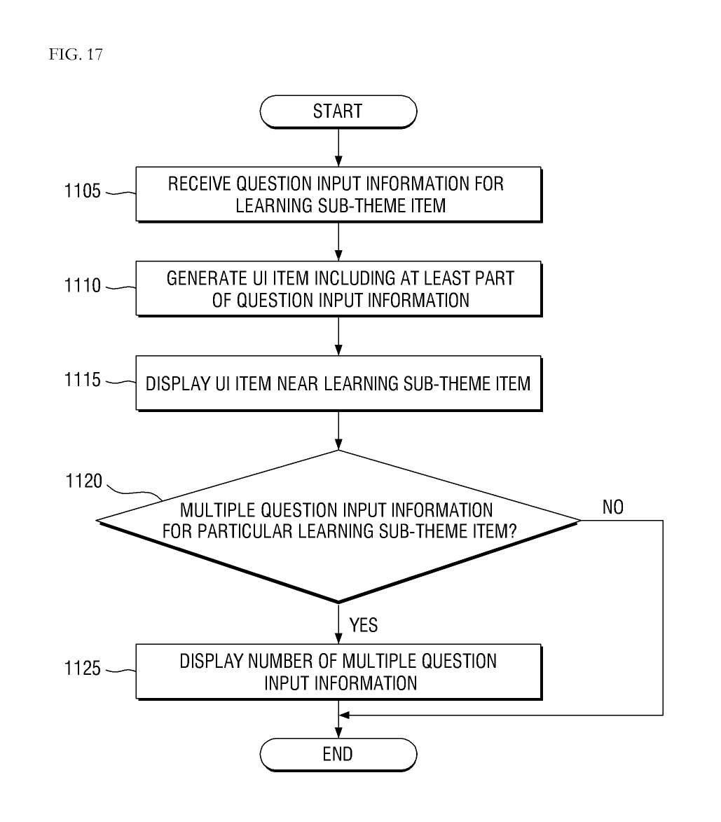

FIG. 17 is a flowchart illustrating a process of receiving question input information by using the electronic device 100.

Referring to FIG. 17, in an exemplary embodiment, in 1105, the electronic device 100 may receive question input information for a learning sub-theme item. For example, the control unit 120 may receive question input information for a learning sub-theme item displayed through the touch screen 160 from the user. The electronic device 100 may also receive question input information for a learning theme item. The received question input information may be text or image data created by the user regarding the displayed learning sub-theme item. For this, the electronic device 100 may display a “Question” icon in one area on the touch screen to allow the user to enter a question for a learning theme item or a learning sub-theme item. In response to the user selecting the “Question” icon and entering and storing a question, the control unit 120 may recognize the entered question as question input information.

In an exemplary embodiment, in 1110, the electronic device 100 may generate a UI item including at least part of question input information. For example, the control unit 120 may process question input information received from the user in the form of a UI item. In this example, the UI item may be realized as text or image data including at least part of the question input information received from the user.

In an exemplary embodiment, in 1115, the electronic device 100 may display the generated UI item near a corresponding learning theme item or a corresponding learning sub-theme item. For example, the control unit 120 may control the touch screen 160 to display the generated UI item near the corresponding learning theme item or the corresponding learning sub-theme item. The user may identify that his or her question is being registered near the corresponding learning sub-theme item and may thus be able to efficiently learn.

In an exemplary embodiment, in 1120, the electronic device 100 may determine whether there are a plurality of question inputs for a particular learning sub-theme item.

For example, the control unit 120 may determine whether a plurality of questions have been registered for a particular learning sub-theme item. The electronic device 100 may also determine whether there are a plurality of question inputs not only for a particular learning sub-theme item, but also for a particular learning theme item.

In 1125, in response to there existing a plurality of question inputs for a particular learning theme item or a particular learning sub-theme item, the electronic device 100 may display question input frequency information indicating the number of the plurality of question input information. For example, in response to there existing a plurality of questions registered for a particular learning theme item or a particular learning sub-theme item, the control unit 120 may control the touch screen 160 to display text data indicating the number of the plurality of question input information. The electronic device 100 may display the question input frequency information near the corresponding learning theme item or the corresponding learning sub-theme item.

In an exemplary embodiment, the electronic device 100 may share various data for providing learning information with the external server 200. In an exemplary embodiment, the electronic device 100 may transmit question input information received from the user to the external server 200 through the communication unit 170, and the external server 200 may receive answer information for the question input information from the service provider. The external server 200 may transmit the received answer information to the electronic device 100.

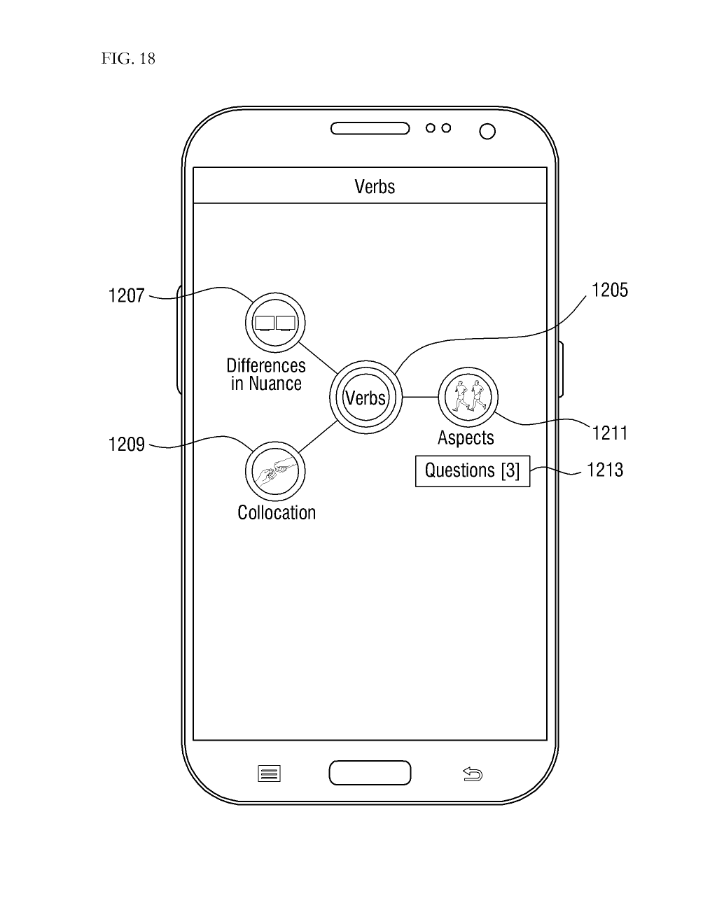

FIG. 18 is an exemplary view illustrating a process of registering question input information to be displayed near a learning sub-theme item through the process of FIG. 17.

Referring to FIG. 18, the electronic device 100 displays a learning theme item 1205, learning sub-theme items 1207, 1209, and 1211, and a UI question item 1213 through the touch screen 160. The UI question item 1213 is a UI item generated and displayed in response to receipt of question input information regarding the learning sub-theme item 1211 from the user. For this, although not illustrated, the user may enter a question regarding the learning sub-theme item 1211 through an additional UI menu. The control unit 120 may receive question input information from the user, may generate a UI question item 1213 including at least part of the received question input information, and may display the generated UI question item 1213 near the learning sub-theme item 1211.

In response to a plurality of question input information being received for the learning sub-theme item 1211, the electronic device 100 may display the number of the plurality of question input information. For example, in response to three questions being registered for the learning sub-theme item 1211, as illustrated in FIG. 18, the electronic device 100 may generate and display a UI question item 1213 including text that says, “Questions (3)”. Accordingly, the user or the service provider may easily identify the number of questions registered for a particular learning sub-theme item and may thus effectively communicate with each other.

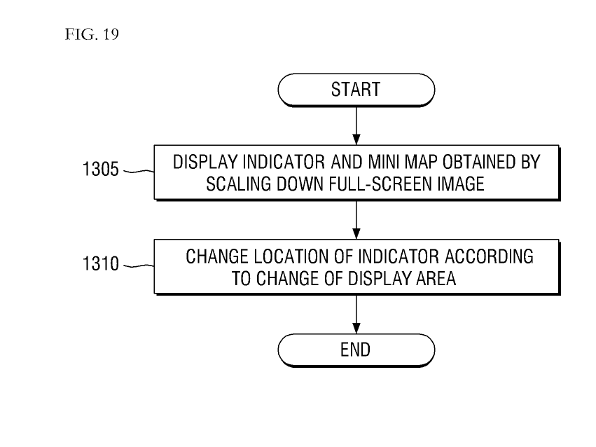

FIG. 19 is a flowchart illustrating a process of displaying a mini map of a full-screen image by using the electronic device 100.

Referring to FIG. 19, in an exemplary embodiment, in 1305, the electronic device 100 may display a mini map, which is a scaled-down version of a full-screen image, and an indicator. For example, the control unit 120 may scale down a full-screen image in which a learning theme item, at least one learning sub-theme item, and at least one additional sub-theme item are all displayed, thereby generating a mini map.

The control unit 120 may control the touch screen 160 to display the generated mini map on a particular area on the touch screen 160. The full-screen image may be displayed as a whole at a reduced scale in the mini map even when not all the learning information items included in the full-screen image are displayed on the touch screen 160. That is, the full-screen image may be displayed as a whole at a reduced scale in the min map even when only some of the learning information items included in the full-screen image are displayed.

The electronic device 100 may generate an indicator to be displayed in the min map. The indicator may be a UI item indicating which part of the full-screen image is currently being displayed through the touch screen 160.

In an exemplary embodiment, in 1310, the electronic device 100 may change the location of the indicator according to a change of the display area of the touch screen 160. For example, in response to one or more learning sub-theme items or additional learning sub-theme items being displayed, the electronic device 100 may move the display area of the touch screen 160 so as for any additional learning information item added to be included in the display area of the touch screen 160. In this example, the control unit 120 may control the touch screen 160 to guide the user as to which part of the full-screen image is currently being displayed on the touch screen 160.

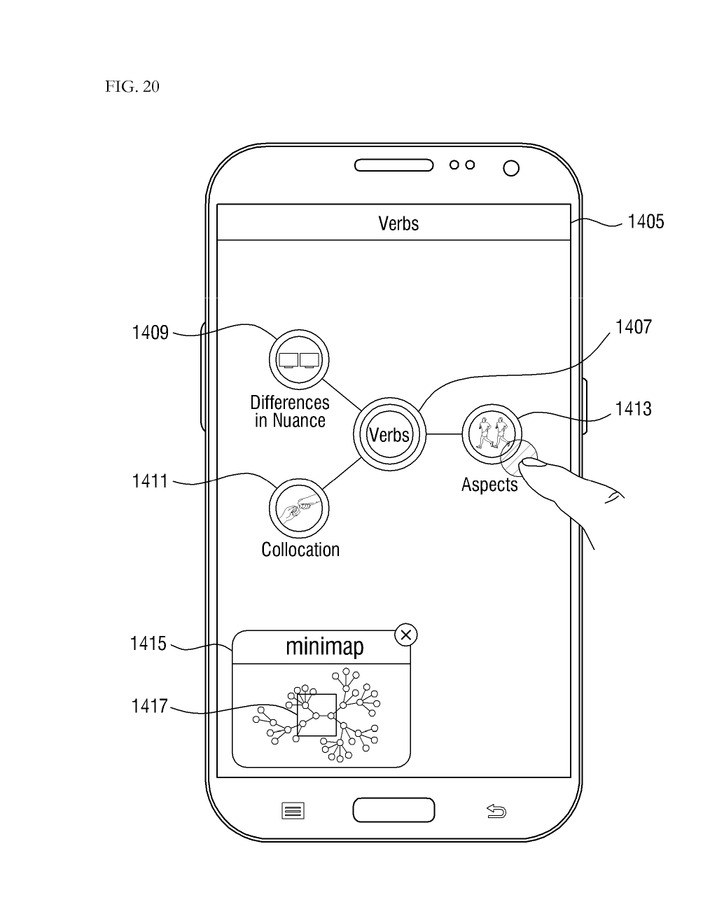

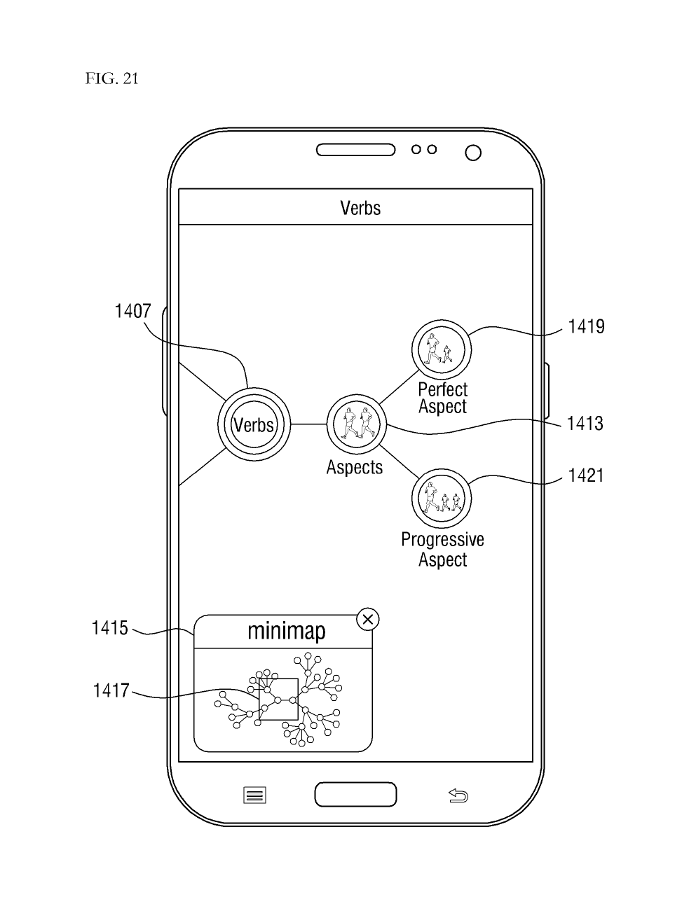

FIGS. 20 and 21 are exemplary views illustrating the process of FIG. 19.

Referring to FIG. 20, the electronic device 100 displays a learning theme window 1405, a learning theme item 1407, and learning sub-theme items 1409, 1411, and 1413 on the touch screen 160. The electronic device 100 also displays a mini map 1415 including an indicator 1417 in one area through the touch screen 160. As illustrated in FIG. 20, the mini map 1415 is a scaled-down version of a full-screen image, and the indicator 1417 may indicate which part of the full-screen image is currently being displayed on the touch screen 160.

Even though only the learning theme item 1407 and the learning sub-theme items 1409, 1411, and 1413, among other learning information items, are currently being displayed through the touch screen 160, the mini map 1417 may display the entire full-screen image therein. In response to receipt of a touch input for an “End” icon included in the mini map 1415 from the user, the electronic device 100 may delete the mini map 1415 from the touch screen 160.

FIG. 21 illustrates a state in which in response to receipt of a touch input for the learning sub-theme item 1413, additional learning sub-theme items 1419 and 1421 are displayed and the location of the indicator 1423 in the mini map 1415 is changed according to a corresponding change of the display area of the touch screen 160.

Referring to FIG. 21, the electronic device 100 may display the learning sub-theme item 1413 for which a touch input is received from the user to be displayed at the center of the touch screen 160. Accordingly, the display area of the touch screen 160 changes, and the control unit 120 may control the location of the indicator 1423 in the mini map 1415 so as to reflect the corresponding change of the display area of the touch screen 160.

As mentioned above, the electronic device 100 may display a mini map and an indicator, which represent a full-screen image, on the touch screen 160, and may thus provide a clear view of a learning information structure to the user.

What is claimed is:

1. An electronic device, comprising:
a storage unit storing at least one data regarding learning information;
a touch screen receiving a user input and displaying the at least one data; and
a control unit displaying a learning theme item and at least one learning sub-theme item related to the learning theme item through the touch screen by mapping the at least one learning sub-theme item to the learning theme item, receiving a predefined user input for the at least one learning sub-theme item, and controlling the touch screen to display a notification window including image data and text data regarding the at least one learning sub-theme item according to the predefined user input.

2. The electronic device of claim 1, wherein the control unit controls the touch screen to display the notification window to slide from a predetermined area on the touch screen in at least one direction.

3. The electronic device of claim 2, wherein the notification window includes image data regarding the at least one learning sub-theme item, a description of the image data, a summary of the at least one learning sub-theme item, and a summary of at least one additional learning sub-theme item related to the at least one learning sub-theme item.

4. The electronic device of claim 1, wherein the control unit receives a user input for a particular user interface (UI) item included in the notification window and controls the touch screen to display at least one additional learning sub-theme item related to the at least one learning sub-theme item according to the received user input.

5. The electronic device of claim 4, wherein the control unit receives a user input for the at least one additional learning sub-theme item and controls the touch screen to provide learning content corresponding to the at least one additional learning sub-theme item according to the received user input.

6. An electronic device, comprising:
a storage unit storing at least one data regarding learning information;
a touch screen receiving a user input and displaying the at least one data; and
a control unit controlling the touch screen to display a full-screen image, in which all learning theme items, all learning sub-theme items, and all additional learning sub-theme items included in the learning information are displayed at a predetermined reduced scale, according to a predefined user input.

7. The electronic device of claim 6, wherein the control unit controls the touch screen to scale up or down the full-screen image according to a drag input received from a user.

8. The electronic device of claim 6, wherein the control unit displays a UI menu including grade information or publisher information through the touch screen in response to receipt of a user input for displaying the UI menu, receives a user selection input regarding the grade information or the publisher information through the touch screen, and updates and displays the at least one learning theme item and the at least one learning sub-theme item according to the received user selection input.

9. The electronic device of claim 6, wherein the control unit generates a mini map by scaling down the full-screen image at a predetermined rate, and controls the touch screen to display the mini map on at least part of the screen of the touch screen.

10. The electronic device of claim 9, wherein the control unit generates an indicator, which is included in the mini map and provides guidance as to which part of the full-screen image is currently being displayed through the touch screen, and displays the indicator through the touch screen.

11. An electronic device, comprising:
a storage unit storing at least one data regarding learning information;
a touch screen receiving a user input and displaying the at least one data; and
a control unit displaying a learning theme item and at least one learning sub-theme item related to the learning theme item through the touch screen by mapping the at least one learning sub-theme item to the learning theme item, receiving question input information for the at least one learning sub-theme item through the touch screen, generating a UI item including at least part of the question input information, and controlling the touch screen to display the UI item near the learning theme item or the at least one learning sub-theme item.

12. The electronic device of claim 11, wherein in response to a plurality of question input information being received for at least one of the learning theme item and the at least one learning sub-theme item, the control unit controls the touch screen to display the number of the plurality of question information near the UI item.

13. A method of providing learning information using an electronic device, the method comprising:
displaying a learning theme item and at least one learning sub-theme item related to the learning theme item on the touch screen by mapping the at least one learning sub-theme item to the learning theme item;
receiving a predefined user input for the at least one learning sub-theme item; and
displaying a notification window including image data and text data regarding the at least one learning sub-theme item according to the predefined user input.

14. The method of claim 13, wherein the displaying the notification window, comprises displaying to slide from a predetermined area on the touch screen in at least one direction.

15. A method of providing learning information using an electronic device, the method comprising:
is displaying a learning theme item and at least one learning sub-theme item related to the learning theme item on the touch screen by mapping the at least one learning sub-theme item to the learning theme item; and
displaying a full-screen image, in which all learning theme items, all learning sub-theme items, and all additional learning sub-theme items included in the learning information are displayed at a predetermined reduced scale, according to a predefined user input.

16. The method of claim 15, further comprising:
displaying a UI menu including grade information or publisher information according to a predefined user input;
receiving a user selection input regarding the grade information or the publisher information; and
updating and displaying the at least one learning theme item and the at least one learning sub-theme item according to the received user selection input.

17. The method of claim 15, further comprising:
generating a mini map by scaling down the full-screen image at a predetermined rate; and
displaying the mini map on at least part of the screen of the touch screen.

18. The method of claim 17, further comprising:
generating an indicator, which is included in the mini map and provides guidance as to which part of the full-screen image is currently being displayed through the touch screen; and
displaying the indicator through the touch screen.

19. A method of providing learning information using an electronic device, the method comprising:
displaying a learning theme item and at least one learning sub-theme item related to the learning theme item on the touch screen by mapping the at least one learning sub-theme item to the learning theme item;
receiving question input information for the at least one learning sub-theme item from a user;
generating a UI item including at least part of the question input information; and
displaying the UI item near the learning theme item or the at least one learning sub-theme item.

20. The method of claim 19, further comprising:
in response to a plurality of question input information being received for at least one of the learning theme item and the at least one learning sub-theme item, displaying the number of the plurality of question information near the UI item.
